(19) United States
(12) Patent Application Publication
(10) Pub. No.: US 2018/0103210 A1
(43) Pub. Date: Apr. 12, 2018

(54) CAMERA SYSTEM AND OBJECT RECOGNITION METHOD THEREOF

(71) Applicant: Korea Electronics Technology Institute, Seongnam-si (KR)

(72) Inventors: Young Choong Park, Goyang-si (KR); Kwang Soon Choi, Goyang-si (KR); Yang Keun Ahn, Seoul (KR)

(21) Appl. No.: 15/448,213

(22) Filed: Mar. 2, 2017

(30) Foreign Application Priority Data
Oct. 12, 2016 (KR) 10-2016-0132078

(51) Int. Cl. H04N 5/232; G06T 7/70; G06T 7/11; G06K 9/00; G01S 17/42; G01S 17/02

(52) U.S. Cl. CPC H04N 5/23296; G06T 7/70; G06T 7/11; G06T 2207/20021; G01S 17/42; G01S 17/023; G06T 2207/10028; G06K 9/00201

(57) ABSTRACT

A camera system for object recognition is disclosed. In one aspect, the system includes an active three-dimensional (3D) sensor configured to obtain a 3D point cloud which corresponds to 3D position values of an object, and a controller configured to generate control data for controlling a zoom value, a pan value, and a tilt value which correspond to the 3D position values. The system also includes a camera configured to photograph the object by performing one or more of zooming, panning, and tilting on the basis of the control data.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to and the benefit of Korean Patent Application No. 2016-0132078, filed on Oct. 12, 2016, the disclosure of which is incorporated herein by reference in its entirety.

### BACKGROUND

### Field

The described technology generally relates to a camera system and an object recognition method thereof.

### Description of the Related Art

Currently, a closed-circuit camera system, a face recognition camera system and a license plate recognition camera system employ a technique which uses both a narrow angle lens and a wide angle lens at the same time, in which the wide angle lens is used to detect a specific objet in motion and the narrow angle lens is used to acquire an enlarged image, as disclosed in Korean Laid-Open Publication No. 10-2012-0060339 (entitled “Closed Circuit Camera System Using Narrow Angle Lens and Wide Angle Lens and Practicing Method Thereof”).

However, in the above technique, a three-dimensional (3D) position of a detected object cannot be known, and thus it is difficult to determine how much the object should be zoomed in, and also it is difficult to accurately estimate a direction (pan or tilt) of the object.

In another example, a technique which detects a user's position using a 3D stereo camera and tracks an eye-gaze by controlling a pan value and a tilt value of a narrow angle camera having a fixed angle of view is utilized, as disclosed in Korean Laid-Open Publication No. 10-2013-0133127 (entitled “Gaze Tracking System at a Distance Using Stereo Camera and Narrow Angle Camera”).

However, the above technique has a problem in which it merely tracks the eye-gaze by controlling panning and tilting of the narrow angle camera having a fixed angle of view and does not support an angle-of-view adjustment, i.e., a zooming function.

Therefore, there is a need for a technology capable of controlling a camera by calculating a pan value, a tilt value, and a zoom value of the camera so as to enlarge a specific object at a 3D position by adjusting an angle of view and a direction of the camera.

### SUMMARY

One inventive aspect relates to a camera system which detects a three-dimensional (3D) position of an object using an active 3D sensor capable of accurate sensing a 3D point and controls a camera by calculating a pan value, a tilt value, and a zoom value so as to allow a viewer to zoom in and view a specific object at a 3D position by adjusting an angle of view and a direction of the camera, and an object recognition method in the camera system.

The technical objects of the present invention are not limited to the aforesaid, and other technical objects should be obvious to those skilled in the art from the following description.

In one general aspect, there is provided a camera system for object recognition including: an active 3D sensor configured to obtain a 3D point cloud which corresponds to 3D position values of an object; a controller configured to generate control data for controlling a zoom value, a pan value, and a tilt value which correspond to the 3D position values; and a camera configured to photograph the object by performing one or more of zooming, panning, and tilting on the basis of the control data.

In another general aspect, there is provided an object recognition method in a camera system, the method including: obtaining a 3D point cloud which corresponds to 3D position values of an object sensed by an active 3D sensor; generating control data for controlling a zoom value, a pan value, and a tilt value which correspond to the 3D position values; and photographing the object by performing one or more of zooming, panning, and tilting on the basis of the control data.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram for schematically describing a camera system according to an embodiment of the present invention;

FIG. 2 is a block diagram illustrating a camera system according to an embodiment of the present invention;

FIG. 3 is an exemplary view of a three-dimensional (3D) point cloud obtained by a sensor;

FIG. 4 is an exemplary view for describing the process of recognizing a unit space block in which an object moves;

FIG. 5 is a flowchart illustrating an object recognition method according to an embodiment of the present invention; and

FIG. 6 is a flowchart illustrating an operation of generating control data.

### DETAILED DESCRIPTION OF CERTAIN INVENTIVE EMBODIMENTS

Hereinafter, embodiments of the present invention will be described in detail to be easily embodied by those skilled in the art with reference to the accompanying drawings. The described technology may, however, be embodied in many different forms and should not be construed as being limited to the embodiments set forth herein. In the accompanying drawings, a portion irrelevant to the described technology will be omitted for clarity.

In this disclosure below, when it is described that one comprises (or includes or has) some elements, it should be understood that it may comprise (or include or has) only those elements, or it may comprise (or include or have) other elements as well as those elements if there is no specific limitation.

The described technology is directed to a camera system 100 and an object recognition method thereof.

According to an embodiment of the present invention, a three-dimensional (3D) position of an object may be detected using an active 3D sensor capable of accurate sensing a 3D point and a camera may be controlled by calculating a pan value, a tilt value, and a zoom value so as to allow a viewer to zoom in and view a particular object at a 3D position by controlling an angle of view and a direction of the camera.

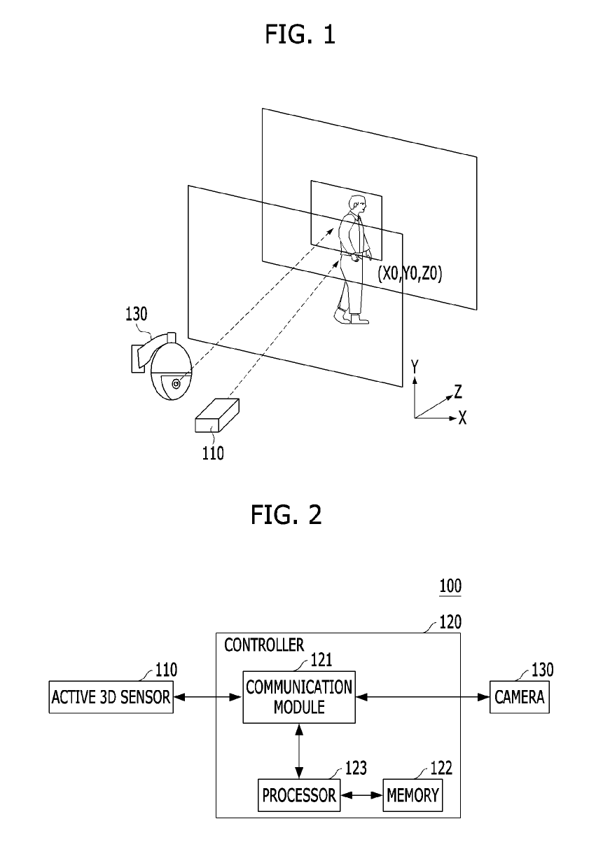

Hereinafter, a camera system 100 according to an embodiment of the present invention will be described with reference to FIGS. 1 to 4.

FIG. 1 is a diagram for schematically describing the camera system 100 according to an embodiment of the present invention. FIG. 2 is a block diagram illustrating the camera system 100 according to an embodiment of the present invention.

The camera system 100 for object recognition according to an embodiment of the present invention includes an active 3D sensor 110, a controller 120, and a camera 130.

Physical elements externally installed are the active 3D sensor 110 and the camera 130, as shown in FIG. 1, and the controller 120 is operated based on a personal computer (PC) in which coded programs are installed.

The active 3D sensor 110 senses 3D position values of an object. In this case, the active 3D sensor 110 may obtain 3D points which correspond to the 3D position values of the object. The active 3D sensor 110 may be laser radar (LADAR), which is active optical radar using a time difference between laser beams sent to and reflected from a target, or a time of flight (TOF) depth camera.

In a related art, a passive stereo camera is generally used, which, however, has disadvantages of having numerous errors in depth extraction and a narrow angle of view. In addition, the stereo camera has a problem in which there is no color difference between two stereo cameras when there is no texture or an object has a similar color to the background, and thus distance calculation errors occur.

However, the camera system 100 according to an embodiment of the present invention uses the active 3D sensor 110, instead of a stereo camera, thereby solving the problems occurring in the related art.

There may be a plurality of active 3D sensors 110 oriented in predetermined directions so as to prevent a blind spot from occurring with respect to a 3D space to be photographed, thereby making it possible to detect an accurate 3D position in a space where an object, such as a person or a vehicle, is located.

The controller 120 generates control data for controlling a zoom value, a pan value, and a tilt value of the camera 130 which correspond to the sensed 3D position values.

The controller 120 may include a communication module 121, a memory 122, and a processor 123.

The communication module 121 may transceive data with the active 3D sensor 110 and the camera 130. In this case, the communication module 121 may include both a wired communication module and a wireless communication module. The wired communication module may be implemented as a power line communication device, a telephone line communication device, a cable home network (MoCA), an Ethernet, an IEEE1294, an integrated wired home network, or an RS-485 control device. In addition, the wireless communication module may be implemented with wireless LAN (WLAN), Bluetooth, high-data-rate wireless personal area network (HDR WPAN), ultra-wideband (UWB), ZigBee, impulse radio, 60 GHz WPAN, binary-code division multiple access (CDMA), a wireless USB technology, a wireless high definition multimedia interface (HDMI) technology, and the like.

The memory 122 stores a program for generating the control data. In this case, the memory 122 collectively refers to a volatile storage device and a non-volatile storage device which preserves stored information even when power is not supplied.

For example, the memory 122 may include a NAND flash memory, such as a compact flash (CF) card, a secure digital (SD) card, a memory stick, a solid-state drive (SSD) or a micro SD card, a magnetic computer storage device, such as a hard-disk drive, an optical disc drive, such as a CD-ROM or a DVD-ROM.

The processor 123 may generate control data for controlling the camera 130 in response to the execution of the program stored in the memory.

More specifically, the processor 123 may generate the control data by adjusting one or both of the pan value and the tilt value so as to adjust the direction of the camera 130 to the direction of the object sensed by the active 3D sensor 110.

In addition, the processor 123 may calculate a distance to the object sensed by the active 3D sensor 110 and generate control data in which the zoom value is adjusted based on the calculated distance.

The camera 130 may photograph the object by performing one or more of zooming, panning, and tilting on the basis of the control data generated by the controller 120.

That is, the camera 130 may precisely adjust its direction to the position where the object is located by performing panning and tilting on the basis of the control data and may photograph the object on the basis of the zoom value, thereby acquiring an enlarged image of the object which is suitable for recognizing a face of a person or a license plate of a vehicle.

In this case, zooming refers to enlarging or reducing an object by adjusting a scaling factor, panning refers to acquisition of an image of the object by moving a camera horizontally, and tilting refers to acquisition of an image of the object by moving the camera vertically.

The camera 130 may be a pan-tilt-zoom (PTZ) camera, and since the camera 130 is configured to identify information of the object, the camera 130 may have higher resolution performance than the active 3D sensor 110 which detects the motion or 3D position values of the object.

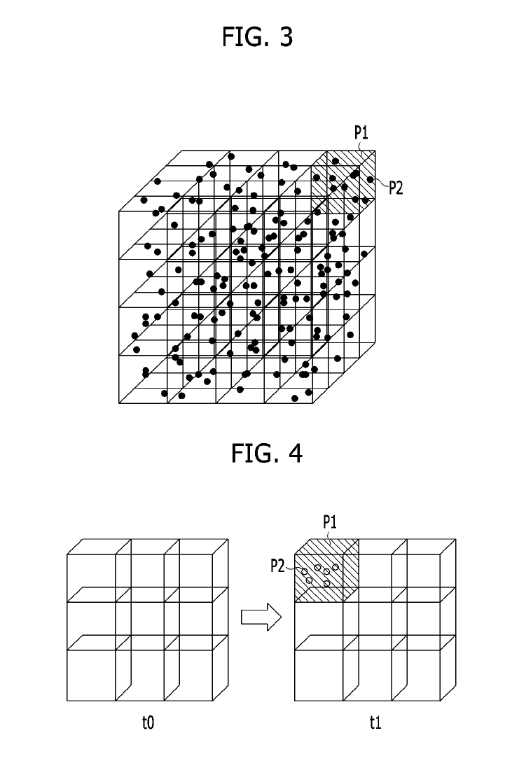

Meanwhile, the camera system 100 according to an embodiment of the present invention may acquire the 3D position values of the object by acquiring a 3D point cloud through the active 3D sensor 110, and the controller 120 may generate the control data for controlling the camera 130, which will be described hereinafter with reference to FIGS. 3 and 4.

FIG. 3 is an exemplary view of a 3D point cloud obtained by the active 3D sensor 110. FIG. 4 is an exemplary view for describing the process of recognizing a unit space block in which the object moves.

When the active 3D sensor 110 obtains the 3D point cloud that corresponds to the object, as shown in FIG. 3, the controller 120 divides a 3D space into unit space blocks of a predetermined size, as shown in FIG. 4(a).

Then, when a change in the number of 3D points P2 in a specific unit space block P1 among the divided unit space blocks during a specific time period (t0-41) exceeds a predetermined amount, as shown in FIG. 4(b), the controller 120 may recognize the specific unit space block P1 as a unit space block in which the object moves.

Accordingly, the controller 120 may generate the control data for adjusting the direction of the camera 130 by setting one or both of the pan value and the tilt value in a 3D center direction of the unit space block P1 recognized as where the object moves.

In addition, the controller 120 may calculate a distance between the 3D center of the unit space block P1 recognized as where the object moves and the camera 130 and generate the control data in which a zoom value is set on the basis of the calculated distance. The camera 130 may photograph the object on the basis of the control data and acquire an enlarged image of the object.

According to the above-described process, the camera system 100 according to an embodiment of the present invention may accurately control the camera 130 by recognizing not only an object in a stationary position, but also an object in motion.

For reference, the elements according to an embodiment of the present invention illustrated in FIG. 2 may each be implemented in the form of software or in the form of hardware such as a field programmable gate array (FPGA) or an application specific integrated circuit (ASIC) and may perform certain functions.

However, the elements are not limited to software or hardware in meaning. In other embodiments, each of the elements may be configured to be stored in a storage medium capable of being addressed, or may be configured to execute one or more processors.

Therefore, for example, the elements may include elements such as software elements, object-oriented software elements, class elements, and task elements, processes, functions, attributes, procedures, subroutines, segments of a program code, drivers, firmware, microcode, circuits, data, databases, data structures, tables, arrays, and variables.

Elements and a function provided in corresponding elements may be combined into fewer elements or may be further divided into additional elements.

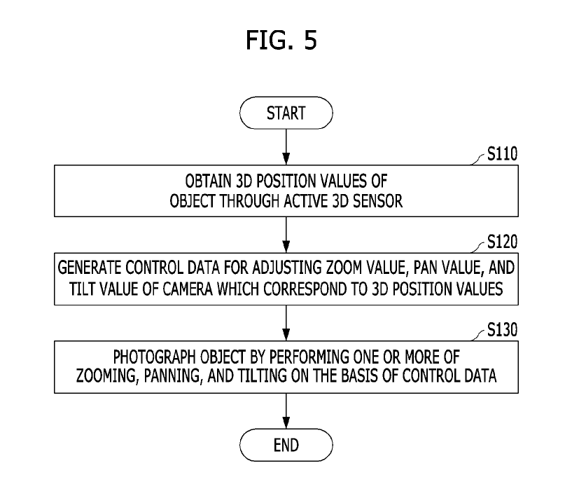

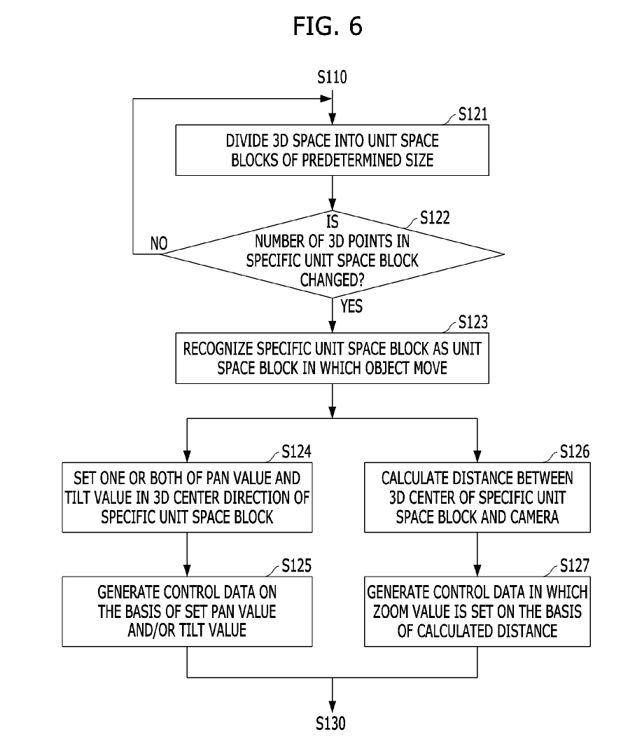

Hereinafter, an object recognition method in the camera system 100 according to an embodiment of the present invention will be described with reference to FIGS. 5 and 6.

FIG. 5 is a flowchart illustrating an object recognition method according to an embodiment of the present invention. FIG. 6 is a flowchart illustrating an operation of generating control data.

In the object recognition method according to an embodiment of the present invention, first, 3D position values of an object sensed by an active 3D sensor 110 are acquired (S110). In this case, the active 3D sensor 110 may obtain a 3D point cloud that corresponds to the 3D position values of the object.

Then, control data for adjusting a zoom value, a pan value, and a tilt value of a camera which correspond to the sensed 3D position values is generated (S120).

In this case, in the operation of generating the control data, as shown in FIG. 6, a 3D space is divided into predetermined unit space blocks (S121), and it is determined whether there is a change in the number of 3D points in a specific space block (S122). When the change in the number of 3D points in a specific unit space block among the divided unit space blocks during a specific time period exceeds a predetermined amount, the specific unit space block is recognized as a unit space block in which the object moves (S123).

As such, when it is recognized that the object moves in the specific unit space block, one or both of the pan value and the tilt value are set in a 3D center direction of the specific space block (S124) and control data for adjusting the direction of the camera is generated on the basis of the set pan value and/or tilt value (S125).

In addition, a distance between the 3D center of the unit space block recognized as where the object moves and the camera is calculated (S126) and control data in which a zoom value is set on the basis of the calculated distance is generated (S127).

Then, the object is photographed by performing one or more of zooming, panning and tilting of the camera on the basis of the generated control data (S130). That is, the direction of the camera may be adjusted to a direction in which the object in a stationary position or in motion is located by performing one or both of panning and tilting of the camera according to the control data, and zooming is simultaneously performed to photograph the object, thereby acquiring an enlarged image of the object.

In the above description, operations S110 to S130 may be further divided into additional operations or may be combined into fewer operations according to an embodiment of the present invention. In addition, some operations may be omitted as necessary and the order of the operations may be changed. Furthermore, although omitted herein, the description with respect to the camera system 100 in FIGS. 1 to 4 applies to the object recognition method in FIGS. 5 and 6.

According to the above-described embodiment of the present invention, it is possible to precisely control the direction of the camera to the direction of the object by sensing an accurate 3D position of the object in space through the active 3D sensor 110.

In addition, an image which is enlarged to an appropriate size by calculating a distance to the object is acquired, thereby allowing accurate recognition of the object.

Moreover, it is possible to solve the problems caused when a passive stereo camera having numerous errors in depth extraction and a narrow angle of view is applied.

Meanwhile, the method according to an exemplary embodiment of the inventive concept may be implemented by a computer program stored in a medium which is executed by a computer, or in a form of a recording medium including an instruction which is executable by the computer. The computer readable medium may be any available medium which is accessible by the computer, and include volatile and non-volatile media, and removable and non-removable media. Further, the computer readable medium may include a computer storage medium and a communication medium. The computer storage medium may include volatile and non-volatile media and removable and non-removable media implemented by any method and technology of storing information such as a computer-readable instruction, a data structure, a program module, or other data. The communication medium may include other data or other transmission mechanisms of a modulated data signal such as a computer readable instruction, a data structure, a program module or a carrier wave, and include any information transmission medium.

While the method and the system of the inventive concept are described with reference to a specific exemplary embodiment, all or a portion of the components or the operations may be implemented by using a computer system having a general-purpose hardware architecture.

While the exemplary embodiments of the inventive concept are described in detail above, it will be understood by those of ordinary skill in the art that various changes and modifications in form and details may be made therein without departing from the spirit and scope as defined by the following claims. Therefore, it will be understood that the exemplary embodiments described above are merely examples in every aspect, and the inventive concept is not limited thereto. For example, each component described in a single type may be implemented in a distributed type, and similarly, components described in the distributed type may be implemented in a combined type.

The scope of the inventive concept should be defined by claims, and it is intended that the inventive concept covers all such modifications and changes by those of ordinary skill in the art derived from a basic concept of the appended claims, and their equivalents.

According to the above-described embodiment of the present invention, it is possible to precisely control a direction of a camera to the direction of an object by sensing an accurate 3D position of the object in space through the active 3D sensor.

In addition, an image which is enlarged to an appropriate size by calculating a distance to the object is acquired, thereby allowing accurate recognition of the object.

Moreover, it is possible to solve the problems caused when a passive stereo camera having numerous errors in depth extraction and a narrow angle of view is applied.

It will be apparent to those skilled in the art that various modifications can be made to the above-described exemplary embodiments of the present invention without departing from the spirit or scope of the inventive technology. Thus, it is intended that the present invention covers all such modifications provided they come within the scope of the appended claims and their equivalents.

What is claimed is:

1. A camera system for object recognition comprising:
an active three-dimensional (3D) sensor configured to obtain a 3D point cloud which corresponds to 3D position values of an object;
a controller configured to generate control data for controlling a zoom value, a pan value, and a tilt value which correspond to the 3D position values; and
a camera configured to photograph the object by performing one or more of zooming, panning, and tilting on the basis of the control data.

2. The camera system of claim 1, wherein the controller divides a 3D space into unit space blocks of a predetermined size, and when a change in the number of 3D points in a specific unit space block among the divided unit space blocks during a specific time period exceeds a predetermined amount, the controller recognizes the specific unit space block as a unit space block in which the object moves.

3. The camera system of claim 2, wherein the controller generates the control data for controlling a direction of the camera by setting one or both of the pan value and the tilt value in a 3D center direction of the unit space block recognized as where the object moves.

4. The camera system of claim 2, wherein the controller calculates a distance between a 3D center of the unit space block recognized as where the object moves and the camera and generates the control data in which the zoom value is set on the basis of the calculated distance and the camera acquires an enlarged image of the object by photographing the object on the basis of the control data.

5. An object recognition method in a camera system, the method comprising:
obtaining a three-dimensional (3D) point cloud which corresponds to 3D position values of an object sensed by an active 3D sensor;
generating control data for controlling a zoom value, a pan value, and a tilt value which correspond to the sensed 3D position values; and
photographing the object by performing one or more of zooming, panning, and tilting on the basis of the generated control data.

6. The object recognition method of claim 5, wherein the generating of the control data includes:
dividing a 3D space into unit space blocks of a predetermined size, and
when a change in the number of 3D points in a specific unit space block among the divided unit space blocks during a specific time period exceeds a predetermined amount, recognizing the specific unit space block as a unit space block in which the object moves.

7. The object recognition method of claim 6, wherein the generating of the control data includes:
setting one or both of the pan value and the tilt value in a 3D center direction of the unit space block recognized as where the object moves; and
generating the control data for controlling a direction of the camera on the basis of the set pan value and/or tilt value.

8. The object recognition method of claim 6, wherein the generating of the control data includes:
calculating a distance between a 3D center of the unit space block recognized as where the object moves and the camera; and
generating the control data in which the zoom value is set on the basis of the calculated distance,
wherein the photographing of the object acquires an enlarged image of the object by photographing the object through the camera on the basis of the control data in which the zoom value is set.
